(19) United States
(12) Patent Application Publication
(10) Pub. No.: US 2016/0161613 A1
(43) Pub. Date: Jun. 9, 2016

(54) SYSTEM AND METHOD FOR USING GNSS TRACKING CORRELATORS FOR TERRESTRIAL BEACONS

(71) Applicant: NextNav, LLC, Sunnyvale, CA (US)

(72) Inventors: Arun Raghupathy, Bangalore (IN); Subramanian S. Meiyappan, San Jose, CA (US)

(21) Appl. No.: 14/954,371

(22) Filed: Nov. 30, 2015

Related U.S. Application Data
(60) Provisional application No. 62/089,147, filed on Dec. 8, 2014.

(51) Int. Cl. G01S 19/37; G01S 19/30; G01S 19/22

(52) U.S. Cl. CPC G01S 19/37; G01S 19/22; G01S 19/30

(57) ABSTRACT

A receiver having a plurality of tracking channels for tracking received positioning signals. A pseudo random number (PRN) sequence is generated in each tracking channel. Each PRN sequence is offset from the PRN sequence generated by each other tracking channel to create a tracking window that can be extended and for which the sample rate can be set.

### RELATED APPLICATIONS

This application relates to U.S. Patent Application Ser. No. 62/089,147, filed Dec. 8, 2104, entitled SYSTEM AND METHOD FOR USING GNSS TRACKING CORRELATORS FOR TERRESTRIAL BEACONS, the content of which is hereby incorporated by reference herein in its entirety.

### FIELD

Various embodiments relate to wireless communications, and more particularly, to tracking terrestrial positioning signals using Global Navigation Satellite System (GNSS) tracking correlators.

### BACKGROUND

It can be very useful to quickly and accurately estimate the location of things within a geographic area. For example, information regarding the location of people can be used to speed up emergency response times. Information regarding the location of things (e.g., people or items) can also track the movement of such things. Most approaches rely on a process called trilateration. Trilateration uses geometry to estimate the position of an object based on the distances traveled by different positioning signals (also referred to as “ranging” signals) that are transmitted from three or more transmitters to receivers that are co-located with the things to be located.

Various networks of transmitters have been used to transmit positioning signals. For example, orbiting satellites in a Global Navigation Satellite System (GNSS), such as the well-known Global Positioning Satellite (GPS) system, transmit positioning signals. Each GNSS satellite transmits a positioning signal on which a pseudo random number (PRN) code (e.g., a Gold code) is modulated. The positioning signal is received by a GNSS receiver. The GNSS receiver identifies the relative time of arrival based on an internal clock in the receiver by correlating the received signal with a locally generated version of the PRN sequence. Using the transmission time and the relative reception times of the positioning signals from at least four satellites, the receiver solves a set of simultaneous equations to determine the position and relative clock offset for the receiver.

It is common for a GNSS receiver to attempt to acquire and track signals transmitted from as many satellites as possible. Often times, there is a direct line of sight from the receiver to up to twelve “visible” satellites from a single satellite constellation, and it is common for a GNSS receiver to have twelve or more tracking channels. Each tracking channel allows the receiver to synchronize a locally generated PRN sequence with the received signal from a different satellite. The tracking channel monitors the distance between the satellite and the receiver by determining the time of arrival. The tracking channel commonly has three taps—e.g., an “early” tap, a “prompt” tap and a “late” tap—to enable it to track the signal accurately. The early tap indicates whether the received signal arrived early; the prompt tap indicates whether the signal arrived promptly; and the late tap indicates whether the signal arrive late. In outdoor “open” environments, due to the direct line of sight between the satellite and the receiver, a simple tracking channel with three taps as described above is sufficient. In more blocked/cluttered environments, GNSS signals experience multipath. As a result, a modern GNSS receiver may have more than three taps to be able to detect the time of arrival more accurately. However, due to the relatively low power of GNSS signals, a large number of taps is not justified since sophisticated signal processing to resolve multipath accurately is not commonly applicable in this low signal-to-noise-ratio (SNR) domain.

GNSS systems work very well in open environments in which a direct line of sight to several satellites exist. However, receiving weak GNSS signals as well as resolving multipath in urban environments, where direct line of sight to satellites often does not exist, poses particular problems. GNSS signals are sent from distant satellites and so are received with low power and often cannot be detected by indoor receivers. Furthermore, the SNR of the received positioning signals may be too low to accurately resolve multipath. One way to address the challenges of determining the position location of a device in an urban environment is to use terrestrial transmitter systems. Such systems that use terrestrial transmitters provide much stronger signals than systems that rely on signals transmitted from satellites.

The use of terrestrial transmitters to transmit positioning signals provides a significant advantage. However, there may not be a direct path from the transmitter to the receiver for signals transmitted by terrestrial transmitters operating in an urban environment. Additionally, receivers that rely on signals from terrestrial systems may receive a significantly greater number of detectable multipath signals spread over a larger duration of time (referred to as multipath spread) than is typically the case when receiving signals from GNSS systems. Therefore, receivers that are intended to receive terrestrial signals typically need to have tracking channels that have more than three taps. Having more taps allows a terrestrial receiver to track several instances of a signal. Since such terrestrial receivers require more than three taps, additional hardware is required to provide tracking channels with the desired number of taps in order to make a GNSS receiver capable of supplementing the received GNSS signals with terrestrial signals.

In addition, some signals transmitted from a terrestrial positioning system may need to penetrate several walls or pass through or around other obstacles that will substantially attenuate the signals. Therefore, terrestrial receivers need to be able to manage signals with a substantially larger dynamic range than GNSS signals (e.g., terrestrial signals arrive at both relatively high power levels and at relatively low power levels).

Examples of terrestrial transmitter systems that transmit positioning signals are described in U.S. Pat. No. 8,130,141 (the “'141 patent”), which is currently owned by the assignee of this disclosure. In at least one embodiment of the '141 patent, each terrestrial transmitter uses a GPS-like channel to transmit a precisely-timed positioning signal. The receiver computes its location by processing the positioning signals from three or more terrestrial transmitters, similar to the way in which the receiver would process GPS positioning signals from three or more GPS satellites. Since most (if not all) receivers are able to process GPS signaling, the signals transmitted by such a terrestrial transmitter system can be used by existing receivers with minimal (or no) modifications to those receivers.

Since terrestrial transmitter systems, such as the system described in the '141 patent, provide additional signals, receivers that use such signals require additional hardware to provide the additional correlator taps needed to track multipath terrestrial positioning signals that have significantly different path lengths. Such additional hardware increases the cost of the receiver. Therefore, it is desirable to reduce or eliminate the need for such additional hardware.

The statements in this section merely provide background information related to the present disclosure and are not intended to constitute an admission of prior art.

### SUMMARY

Embodiments of this disclosure relate generally to systems, methods and machine-readable media for tracking terrestrial positioning signals while reducing the need for additional hardware to increase the number of taps per tracking channel.

In some embodiments, existing GNSS receiver hardware are used to track signals that traversed two or more paths of significantly different path lengths from a terrestrial transmitter to the receiver. For example, in one embodiment, a GNSS receiver having several tracking channels, each having a limited number of correlator taps (e.g., four), is used to receive terrestrial signals that require a relatively large number of correlator taps (e.g., 30). In one implementation, several tracking channels are programmed to receive signals that were transmitted from the same transmitter, where each tracking channel has a PRN generator that is programmed to generate a PRN sequence with a different relative offset to provide a tracking window that: (1) is wider than the window of one tracking channel; or (2) has a greater resolution (i.e., higher sample rate) than one tracking channel; or (3) has both a wider tracking window and greater resolution than one tracking channel—e.g., correlate over a larger delay (chip) spread with a higher sample rate correlation function.

Details of embodiments are set forth in the drawings and the description below.

### BRIEF DESCRIPTION OF THE DRAWINGS

FIG. 1 depicts a simplified block diagram of a receiver having a tracking channel.

FIG. 2A provides additional detail regarding one embodiment of a tracking channel.

FIG. 2B provides additional detail regarding one embodiment of a tracking channel.

FIG. 3 depicts an embodiment of a tracking channel in which four taps are used to create four instances of a locally generated PRN sequence to correlate over two chips with a sample rate of two samples per chip.

FIG. 4 depicts one embodiment of a tracking channel in which four taps are used to create a locally generated PRN sequence with four samples per chip spanning a delay spread of one chip.

FIG. 5 depicts a simplified block diagram of a receiver in which several tracking channels are used.

FIG. 6 depicts a simplified block diagram of a receiver in which a programmable selector distributes the positioning signal to one or more of the tracking channels.

FIG. 7 depicts a sequence of correlation output values resulting from a concatenation of three tracking channels.

FIG. 8 depicts a graph of correlation output values at 4 samples per chip.

FIG. 9 depicts the correlation output values resulting from interleaving two tracking channels of six taps at a sample rate of two samples per chip to achieve an effective sample rate of four samples per chip spanning a delay spread of three chips.

FIG. 10 illustrates a tracking window formed from concatenating twelve tracking channels together.

FIG. 11 details a process for combining tracking channels to increase the number of correlation outputs used to create a tracking window.

Like reference numbers and designations in the drawings indicate like elements.

### DETAILED DESCRIPTION

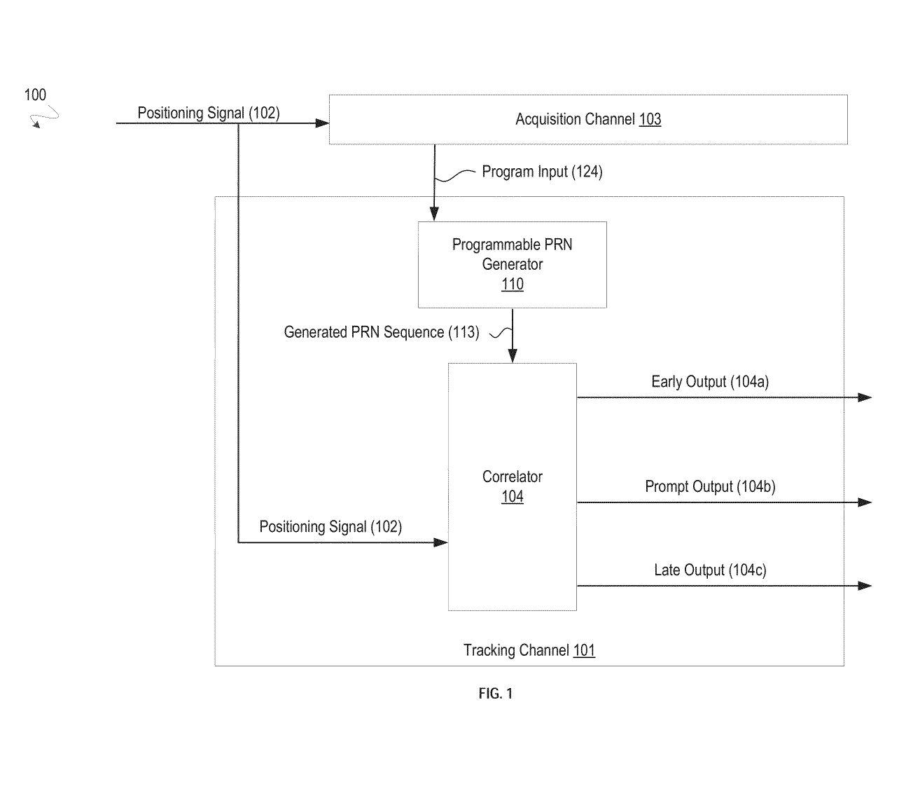

FIG. 1 depicts a simplified block diagram of a receiver 100 having a tracking channel 101. A positioning signal 102 is received by the receiver 100. A positioning signal transmitted by a transmitter may have multiple signal paths between the transmitter and a receiver. Each path of the signal usually arrives at a different time relative to the other paths of the signal. A positioning signal received by the receiver (also referred to as an “input signal”) often includes multiple paths (where each path is sometimes referred to as a “signal component”). Usually, the receiver must distinguish each path to determine the earliest arriving path, which is usually the path that best estimates the true distance between the transmitter and the receiver for use during trilateration.

The positioning signal 102 was modulated before transmission by a transmitter (e.g., a terrestrial transmitter) with a pseudo random number (PRN) code (“sequence”) at a particular chipping rate. Chips are the individual symbols of the PRN sequence that are modulated onto the positioning signal 102 by the transmitter. The chipping rate is the rate at which chips of the PRN sequence change. In one embodiment, the chips are binary values. The values of the chips modulated onto the positioning signal 102 are determined by the PRN sequence.

Initially, the receiver 100 acquires the positioning signal 102 using an acquisition channel 103. During acquisition, the beginning of the PRN sequence that is modulated onto the positioning signal 102 (sometimes referred to as the “epoch” of the PRN sequence) is identified to determine the relative timing of the PRN sequence. Information derived about the PRN sequence (e.g., the timing, phase, chip sequence) is passed to the tracking channel 101 using a program input signal 124.

A programmable PRN generator 110 within the tracking channel 101 receives the program input signal 124 derived from the acquisition channel 103. The program input signal 124 “programs” the PRN generator 110. That is, the program input signal 124 instructs the PRN generator 110 to generate a particular PRN sequence, provides how much delay is associated with each tap of the tracking channel 101 to the PRN generator 110, instructs the PRN generator 110 which taps within the tracking channel 101 to use, instructs the PRN generator 110 to generate the particular PRN sequence at a particular chipping rate, provides a phase offset of the particular PRN sequence to the PRN generator 110, and/or other actions depending on the embodiment. The received program input signal 124 further indicates when to start a locally generated PRN sequence 113 in order to synchronize the locally generated PRN sequence 113 with the PRN sequence of the received positioning signal 102.

The received positioning signal 102 is provided to the tracking channel 101 within the receiver 100. In one embodiment, the received positioning signal 102 is coupled to a correlator 104 within the tracking channel 101. In addition, the locally generated PRN sequence 113 generated by the programmable PRN generator 110 within the tracking channel 101 is coupled to the correlator 104.

In one embodiment, the tracking channel 101 has three correlator taps. Each of the correlator taps correlates a different offset of the locally generated PRN sequence 113 with the positioning signal 102. Thus, each of the correlator taps of the tracking channel 101 is used to determine how correlated the positioning signal 102 is with the generated PRN sequence 113 at the particular offset associated with that correlator tap.

Three correlation outputs are generated from correlating the locally generated PRN sequence 113 with the positioning signal 102. These correlation outputs are shown as an early output 104a, a prompt output 104b and a late output 104c. The sample rate of the correlator 104 indicates the resolution with which the arrival time of the received signal can be determined.

In one embodiment, the acquisition process is carried out with coarse accuracy. Therefore, the tracking channel 101 may need to adjust the timing of the PRN generator 110 to cause the highest correlation peak to occur at the prompt correlation output 104b of the correlator 104.

The highest correlation value may occur at the early output 104a or the late output 104c. By adjusting the timing of the PRN generator 110 using the acquisition information sent via the program input signal 124 as a starting point, the highest correlation value can be moved to occur at the prompt output 104b.

Additional details about tracking channels and correlators are provided below.

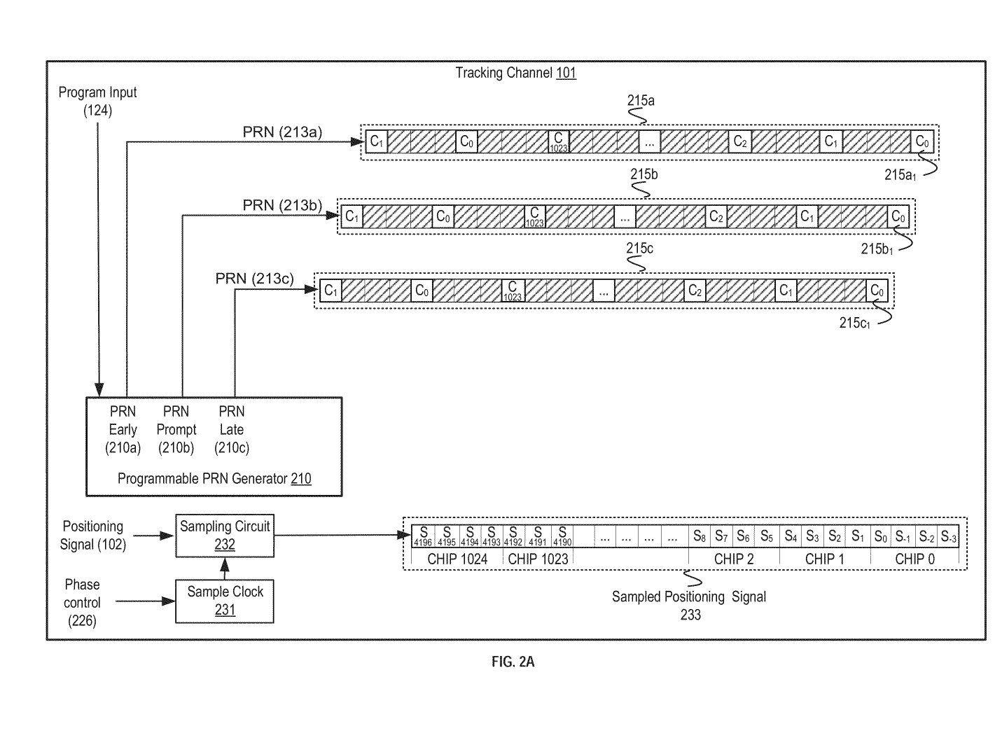

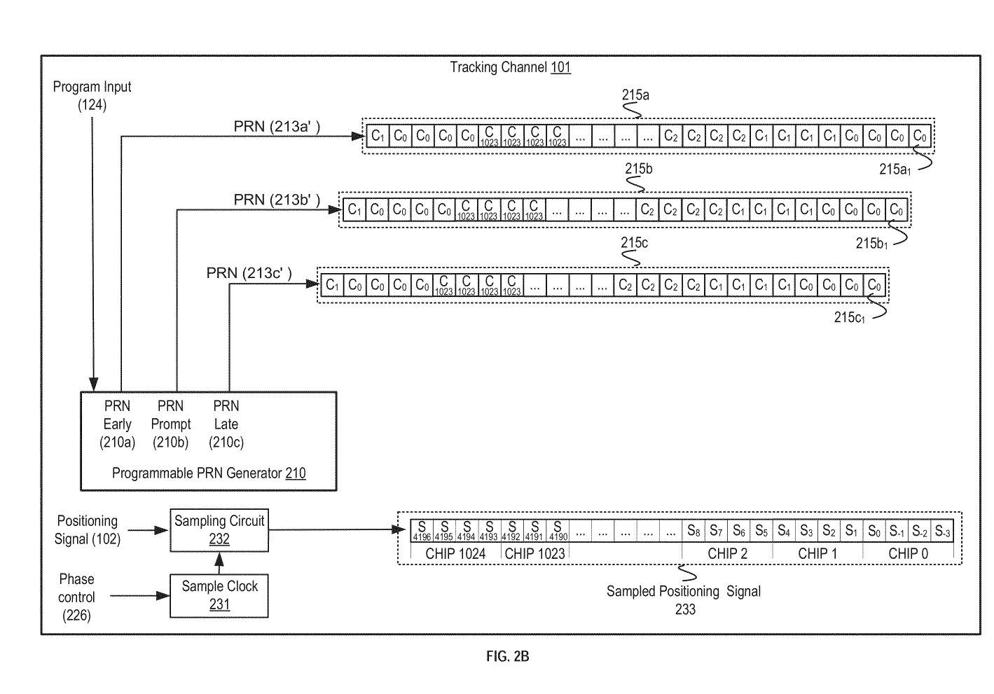

FIG. 2A provides additional detail regarding one embodiment of the tracking channel 101. As discussed with respect to FIG. 1, a programmable PRN generator 210 within the tracking channel 101 creates a locally generated PRN sequence made up of a series of PRN chips.

The program input 124 provides information to the PRN generator 210 as to when the locally generated PRN sequence should begin (e.g., the epoch of the PRN sequence) in order to synchronize the locally generated PRN sequence with the PRN sequence modulated onto the positioning signal 102. The program signal 124 is provided by the acquisition channel 103 as noted above with respect to FIG. 1.

In the system shown in FIG. 2A, the positioning signal 102 received by the tracking channel 101 is coupled to a sampling circuit 232. The sampling circuit 232 samples, or re-samples, the positioning signal 102 at a rate that is equal to or greater than the chipping rate (e.g., the rate that chips of the PRN signal were modulated onto the positioning signal 102). In this example, the sampling rate is four samples per chip. As samples of the positioning signal 102 are generated, those samples are loaded into a sampled positioning signal register 233.

The programmable PRN generator 210 creates the locally generated PRN sequence based on commands received from the program input 124. In an embodiment, the PRN generator 210 generates the individual chips of the locally generated PRN sequence at the same chipping rate as that used for the PRN sequence which was modulated onto the positioning signal 102.

Three taps—210a, 210b and 210c—within the programmable PRN generator 210 are used to generate three instances of the locally generated PRN sequence: an “early”, “prompt” and “late” sequence as was discussed in relation to FIG. 1. Each of the three PRN sequences is offset relative to the other two sequences by using the three taps to provide three different delays.

The early tap 210a is used to generate an early PRN sequence 213a (e.g., a PRN sequence with little or no offset). The prompt tap 210b is used to generate a PRN sequence 213b which is offset by a fractional and/or integer number of chips relative to the beginning of the early PRN sequence 213a. The late tap 210c is used to generate a PRN sequence 213c which is offset by a fractional and/or integer number of chips relative to the beginning of the prompt PRN sequence 213b.

In one embodiment, as chips of the PRN sequences 213a, 213b and 213c are generated, they are loaded into respective PRN sequence registers 215a, 215b and 215c.

As was discussed in FIG. 1, each of the three instances of the locally generated PRN sequences 213a, 213b and 213c are correlated against samples of the positioning signal 102. The blocks within the three PRN sequence registers 215a, 215b and 215c shown with hash marks are not used in the correlation.

In FIG.1, it is implicitly assumed that the pulse matched filtering (matching to the pulse shape of the chip at the transmitter) is performed before the positioning signal at 102 is obtained. For example, in the case of GPS C/A signal, the chip pulse shape is rectangular and therefore the pulse matched filter would be a rectangular pulse also. For systems that use a pulse shape of h(t), then the pulse matched filter is matched to h(t). Note that in some implementation architectures the correlator block 104 would include the pulse shaping filter.

In one embodiment the PRN sequences stored in the PRN sequence registers 215a, 215b and 215c are each correlated against samples of the positioning signal 102 stored within the sampled positioning signal register 233. The resulting correlation output value from each of the three correlation operations can be used to adjust the timing, alignment, or phase of the PRN generator 210 to produce a maximum correlation value when the prompt PRN sequence 213b is correlated against samples of the positioning signal 102.

In one embodiment, the receiver 100 tracks the positioning signal 102 by continuously adjusting the timing of the PRN generator 210 to ensure that the highest correlation peak occurs when a sequence of samples within the sampled positioning signal register 233 are correlated against the prompt PRN sequence 213b stored within the PRN sequence register 215b.

If the correlation output value resulting from correlating the early PRN sequence 213a against the sequence of samples within the sampled positioning signal register 233 is high, then the locally generated PRN sequence output from the programmable PRN generator 210 is delayed to attempt to realign the tracking channel 101 with the positioning signal 102.

Likewise, if the correlation output resulting from correlating the late PRN sequence 213c against the sequence of samples within the sampled positioning signal register 233 is high, then the locally generated PRN sequence output from the programmable PRN generator 210 is advanced to attempt to realign the tracking channel 101 with the positioning signal 102.

By using three instances of a PRN sequence offset in time, the correlation values from each of the PRN sequences 213a, 213b and 213c against the samples of the positioning signal 102 indicate the relative time of arrival of the received positioning signal 102.

In alternative embodiments, a tracking channel can have more than three taps (e.g., four taps, six taps, twelve taps, etc.) and operate similarly with those additional taps.

In addition, the alignment of the samples held in the sampled positioning signal register 233 can be adjusted to achieve the highest correlation with one of the PRN sequences 213a, 213b or 213c.

The number of taps, number of bins in the sampled positioning signal register 233, and number of bins in the three PRN sequence registers 215a, 215b and 215c shown are selected for the purpose of illustration only. The number of samples of the positioning signal 102 and the sample rate used by the sampling circuit 232 may vary significantly from that shown in FIG. 2A, or as will be shown in FIG. 2B. Many ways for implementing a tracking correlator are contemplated.

In one embodiment, samples of the positioning signal 102 can be placed into several tap registers offset by a number of sample bins. Each received signal tap register can be correlated with a locally generated PRN sequence loaded into a PRN register. Other implementations for implementing a multi-tap correlator are known in the art. The particular implementations shown in FIG. 2A and FIG. 2B are provided merely as illustrative examples.

FIG. 2B provides additional detail regarding another embodiment of the tracking channel 101. In correlators implemented for GNSS systems which have a rectangular pulse shape, the code chips are copied to create different code sequences 213a′, 213b′ and 213c′ at the same sample rate as the samples input signal as shown in FIG. 2B. When tracking correlators, such as that shown in FIG. 2B, are to be re-used for a system with a different pulse shape, then a different filter may need to be used in place of a pulse matched filter so that the combination of that different filter combined with the tracking correlator as shown in FIG. 2B produces a total filter that closely matches the transmit pulse shape.

### Generating Correlation Values at a Variable Correlation Sample Resolution Over a Variable Length Delay Spread Using Tracking Channels within GNSS Receiver Hardware

As discussed above, to accurately estimate the position of a receiver using positioning signals received from terrestrial transmitters, signal processing algorithms of the receiver may need to correlate received positioning signals over a wider range of chips (e.g., delay spread) and use a higher correlation sampling rate than what could normally be produced by a tracking channel designed for tracking positioning signals from a satellite positioning system.

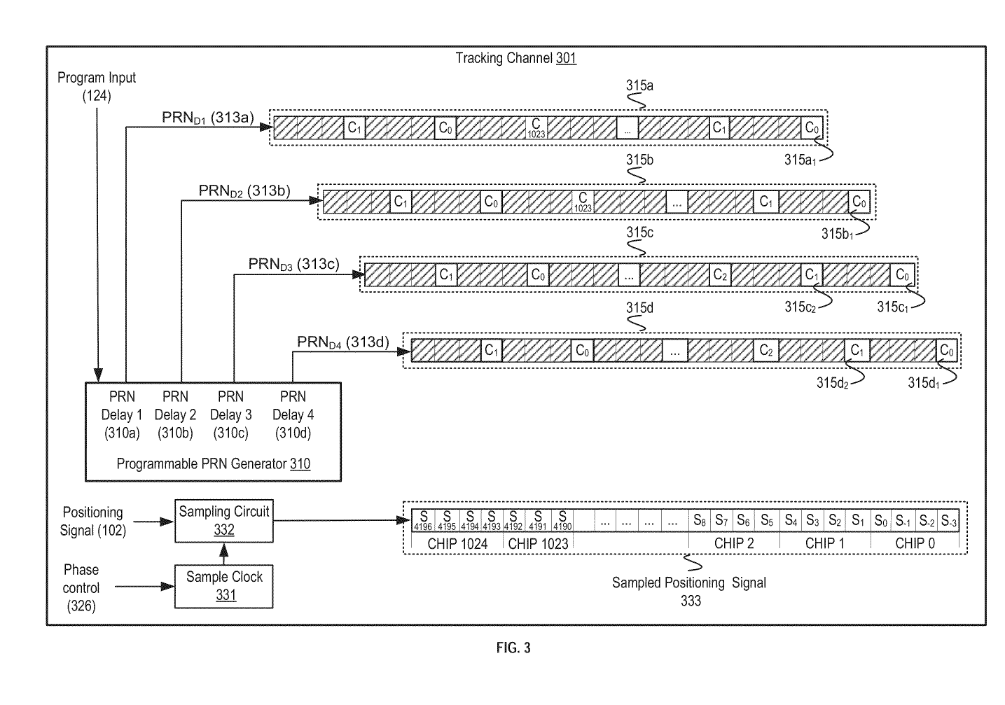

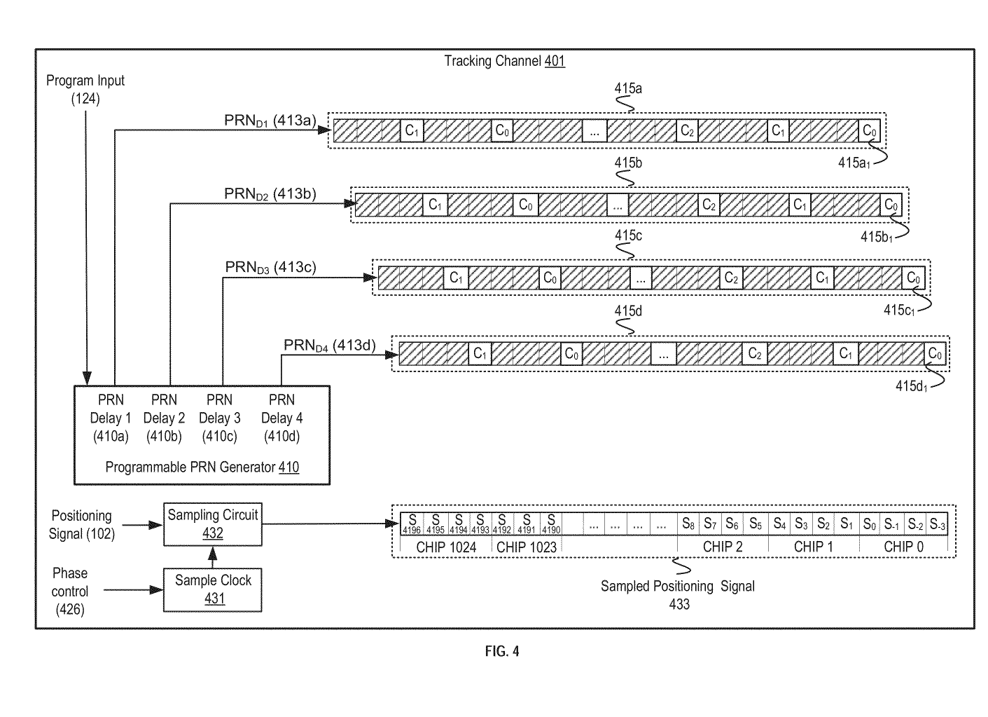

In order to achieve the delay spread window and correlation sample resolution needed to support such signal processing algorithms, tracking channels within GNSS receiver hardware are repurposed to become “building blocks” that can be combined to create correlation windows spanning a variable range of chips with a variable range of chip sampling rates. FIG. 3 and FIG. 4 depict embodiments of such building blocks.

FIG. 3 depicts one embodiment of a tracking channel 301 in which four taps—310a, 310b, 310c and 310d—are used to create four instances of a locally generated PRN sequence to correlate over two chips with a sample rate of two samples per chip.

In this example the incoming positioning signal 102 is sampled by the sampling circuit 332 at a rate of four samples per chip. The four taps within a PRN generator 310 are used to generate four instances—313a, 313b, 313c and 313d—of the locally generated PRN sequence with a half chip offset. That is, the PRN sequence 313c is offset from the PRN sequence 313d by half a chip, the PRN sequence 313b is offset from the PRN sequence 313c by half a chip, and so on. As such, each chip value of the locally generated PRN sequence is multiplied against four different samples of the sampled positioning signal 102 within every span of eight samples of the sampled positioning signal 102 during computation of correlation output values.

Thus, the four PRN sequences—313a, 313b, 313c and 313d—are correlated with the samples of the positioning signal 102 to produce four correlation outputs values spanning a delay spread that is two chips wide. These correlation output values can then be used with high resolution signal processing methods, or other signal processing methods known in the art, to locate the multipath components of the received positioning signal 102.

High-resolution methods are a class of efficient multipath-resolution methods which use Eigen-space decompositions to locate the multipath components. Methods such as MUSIC, ESPRIT fall under this class of resolution schemes. They are highly powerful schemes as in they can resolve effectively much more closely spaced multipath components than traditional signal processing methods. The high resolution earliest time of arrival method attempts to estimate directly the time of arrival of earliest path rather than inferring the peak position from the peak values.

As will be discussed later, an implementation of a tracking channel as shown can be used in combination with other similar tracking channels to correlate over a wider delay spread with a higher correlation sampling resolution than a typical GNSS tracking channel implementation would allow.

The timing of the received positioning signal 102 relative to the locally generated PRN sequence can be adjusted by adjusting either the timing of the PRN sequence or adjusting the phase of the sample clock, but each correlation output will be adjusted by the same amount. Therefore, the relative timing between correlation outputs is fixed. Stated another way, the relative spacing of the correlation outputs from a tracking channel is fixed. The tracking window created by a tracking channel can slide forward or backward in time, but the size of the correlation window associated with one tracking channel is fixed.

FIG. 4 depicts one embodiment of a tracking channel 401 in which four taps—410a, 410b, 410c and 410d—are used to create a locally generated PRN sequence with four samples per chip spanning a delay spread of one chip.

As in FIG. 3, a sampling circuit 432 samples the received positioning signal 102 at a rate of four samples per chip. In one embodiment, as samples of the positioning signal 102 are created they are loaded into a sampled positioning signal register 433.

A programmable PRN generator 410 produces a locally generated PRN sequence corresponding to the PRN sequence modulated onto the received positioning signal 102. The four taps—410a, 410b, 410c and 410d—within the PRN generator 410 create four instances of the locally generated PRN sequence—413a, 413b, 413c and 413d—offset in time relative to each other.

Relative to the PRN sequence 413d, the PRN sequence 413c is delayed by a quarter chip; relative to the PRN sequence 413c, the PRN sequence 413b is delayed by a quarter chip; and relative to the PRN sequence 413b, the PRN sequence 413a is delayed by a quarter chip. As such, each chip value of the locally generated PRN sequence will be multiplied against four contiguous samples of the positioning signal 102 within every span of four samples of the sampled positioning signal 102 during computation of correlation output values.

Thus, the four PRN sequences—413a, 413b, 413c and 413d—are correlated with the samples of the positioning signal 102 to produce four correlation output values spanning a delay spread that is one chip wide. These four correlation output values can then be used as inputs to a signal processing algorithm as was discussed at FIG. 3.

### System Modules Used to Concatenate and/or Stagger Individual Tracking Channel Modules

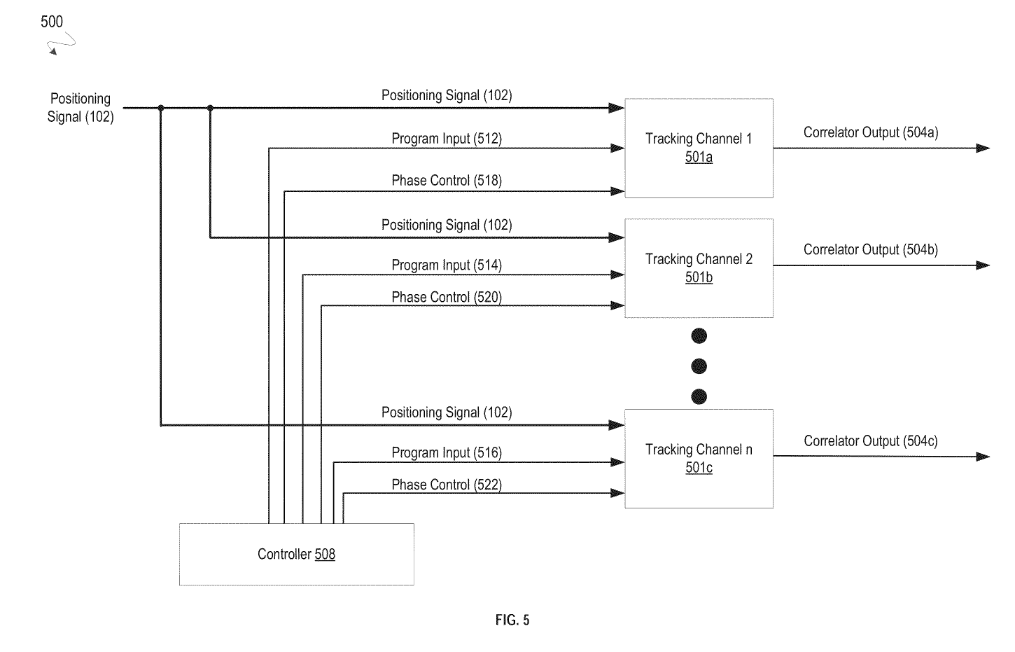

FIG. 5 depicts a simplified block diagram of a portion of a receiver 500 in which several tracking channels are used. Three tracking channels—501a, 501b and 501c—are shown. However, it will be understood that several more such tracking channels may be present as indicated by the ellipses. A received signal 102 is coupled to an input to each of the tracking channels 501a, 501b and 501c.

In one embodiment, each of the tracking channels—501a, 501b and 501c—is a navigation tracking channel and operates essentially in the manner as discussed above with regard to the tracking channel 301 of FIG. 3 or the tracking channel 401 FIG. 4. Any tracking channel having a programmable PRN generator can be implemented.

In one embodiment, the receiver 500 is a navigation receiver and one or more of the tracking channels 501a, 501b and 501c has three or more taps each.

It will be understood by those skilled in the art that tracking channels having other numbers of taps can be used. Furthermore, each tracking channel is not limited to having the same number of taps as the other tracking channels. Thus, in one embodiment, at least two tracking channels have different numbers of taps relative to each other.

As shown in FIG. 5, a controller 508 provides a program input signal 512 to the tracking channel 501a to set the PRN sequence and the timing of the PRN sequence generated by a programmable PRN generator within the tracking channel 501a (e.g., one such as the PRN generator 110, the PRN generator 310, the PRN generator 410). The controller 508 also provides a program input signal 514 to the tracking channel 501b, and a program input signal 516 to the tracking channel 501c.

The program input signal 514 programs a PRN generator within the tracking channel 501b to generate a copy of the PRN sequence generated by the first tracking channel 501a.

The program input signal 516 programs a PRN generator within the tracking channel 501c to also generate a copy of the PRN sequence generated by the first tracking channel 501a.

The copy of the PRN sequence generated by the tracking channel 501b and the copy of the PRN sequence generated by the tracking channel 501c are both offset from the PRN sequence generated by the first tracking channel 501a to establish a correlation window formed by the combination of the tracking channels 501a, 501b and 501c.

The program input signals—512, 514 and 516—can determine whether one or more copies of the PRN sequence are offset by a fractional and/or integer number of chips or samples, thus aligning or offsetting the chip boundaries.

Copies of the PRN sequence can be offset by an amount that causes the boundary of a copy of the PRN sequence generated by one tracking channel to be offset from the boundary of a copy of the PRN sequence generated by each other tracking channel (e.g., the PRN sequences can be concatenated with each other).

Alternatively, each copy of the PRN sequence can be offset with respect to an arbitrarily selected time at which the epoch (i.e., the beginning) of a reference PRN sequence occurs. The reference PRN sequence need not be generated itself, but may establish a reference time from which each of the generated PRN sequences generated in each tracking channel is offset.

In one embodiment, the controller 508 provides phase control signals 518, 520 and 522 to respective tracking channels 501a, 501b and 501c. The phase control signal adjusts the phase of the sample clock (e.g., such as the sample clock 231, the sample clock 331, the sample clock 431) to control the relative time at which each of the tracking channels 501a, 501b and 501c samples the positioning signal 102.

It should be noted that either the start time of the PRN sequence can be offset or the phase of the sample clock can be adjusted in order to alter the correlation between the input signal and the locally generated PRN sequence. The same result can be achieved by shifting the start time of the PRN sequence generated by a tracking channel's PRN generator by a fraction of a sample time.

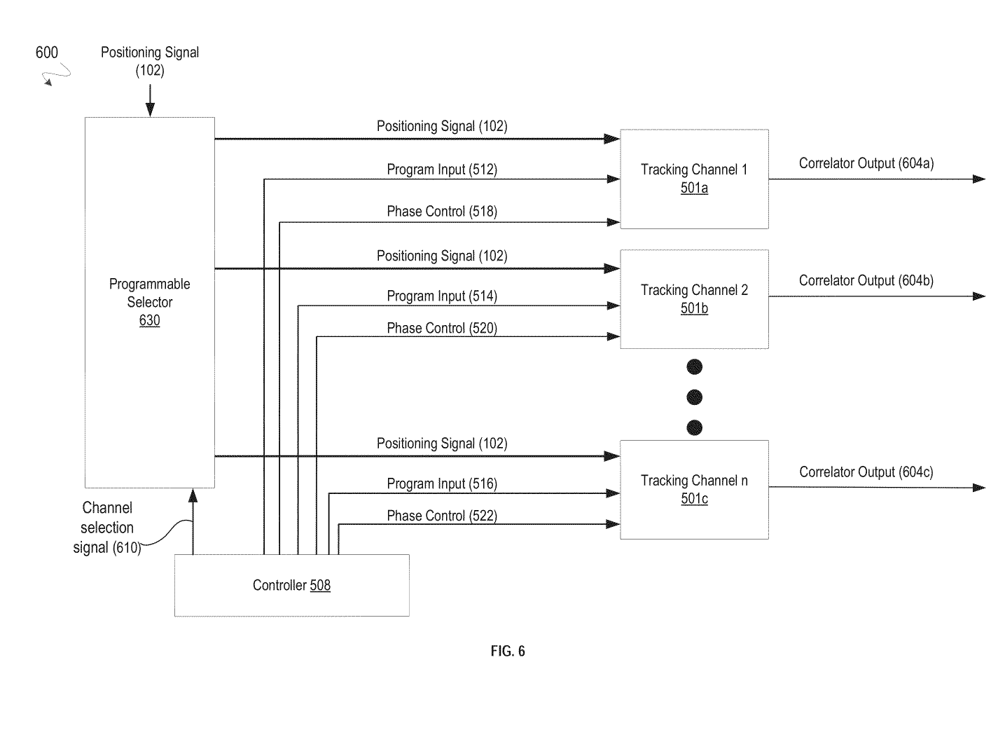

FIG. 6 depicts a simplified block diagram of one embodiment of a receiver 600 in which a programmable selector 630 distributes the positioning signal 102 to one or more of the tracking channels 501a, 501b and 501c. The controller 508 provides a channel selection signal 610 to the programmable selector 630 to determine which of the tracking channels 501a, 501b and 501c are to be used to form a tracking window. Selection of the particular tracking channels 501a, 501b and 501c to which the positioning signal 102 is to be coupled depends upon how many tracking channels are to be used to establish a correlation window, as will be discussed in greater detail below.

By using such embodiments as shown in FIG. 3 though FIG. 6, receiver tracking channels may be combined to correlate a PRN sequence with a received positioning signal across a correlation window that spans a range of chips. The receiver tracking channels may be combined in such a way that a range of chip sample rates may be achieved.

### Example Correlation Output Values from Concatenated and/or Interleaved Tracking Channels

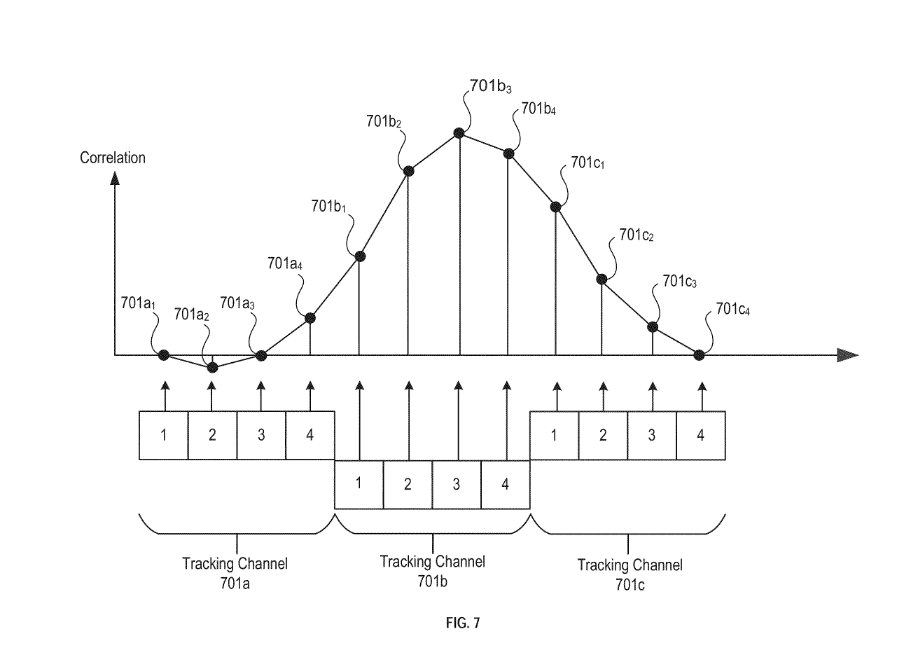

FIG. 7 depicts a sequence of correlation output values (701a₁ through 701a₄, 701b₁ through 701b₄, and 701c₁ through 701c₄) resulting from a concatenation of three tracking channels, 701a through 701c.

In this example each of the tracking channels 701a through 701c is implemented in the same manner as the tracking channel 401 of FIG. 4. The three tracking channels 701a through 701c produce four correlation output values per tracking channel. The four correlation output values from each tracking channel spans a width of one chip. Thus, by concatenating the three tracking channels 701a through 701c, a correlation window spanning three chips with a correlation sampling resolution of four samples per chip is achieved.

As shown, the three tracking channels 701a through 701c combined use a total of twelve taps to generate twelve correlation output values spanning three chips: 701a₁ through 701a₄; 701b₁ through 701b₄; and 701c₁ through 701c₄. This tracking window is three times as long as the tracking window provided by each of the tracking channels 701a, 701b or 701c.

The description that follows describes how the tracking channels may be concatenated using a system such as was described in FIG. 5. In one embodiment, the three tracking channels 701a, 701b and 701c are programmed according to the three tracking channels 501a, 501b and 501c as was described in FIG. 5. Discussion about FIG. 7 below also makes reference to aspects shown in FIG. 5.

The correlation window seen in FIG. 7 is achieved by offsetting the start of the PRN sequence of the second tracking channel 501b with respect to the start of the PRN sequence of the first tracking channel 501a by an integer number of PRN chips. The tracking window is further extended by offsetting the start of the PRN sequence of the third tracking channel 501c with respect to the start of the PRN sequence of the second tracking channel 501b by an integer number of PRN chips. The integer number of PRN chips in both cases may be the same amount or different amounts depending on the embodiment.

In one embodiment, the PRN sequence generated by the second tracking channel 501b begins a predetermined number of chips after the PRN sequence of the first tracking channel 501a, and the PRN sequence generated by the third tracking channel 501c begins a predetermined number of chips after the PRN sequence of the second tracking channel 501b.

In one implementation, the predetermined number is equal to the length of the correlation window of the first tracking channel 501a. Alternatively, the start of the PRN sequence of the second tracking channel 501b and/or the third tracking channel 501c can be offset by an integer number of PRN chips plus a fraction of a chip.

In one embodiment, each tracking channel 501a, 501b and 501c performs four correlations spaced one quarter of a chip apart (i.e., a correlation sampling rate of four samples per chip). That is, the offset between the beginnings of the first (e.g., the sequence with the least delay) of four PRN sequences generated in the second tracking channel 501b, with respect to the first of four PRN sequences generated in the first tracking channel 501a, is one chip. The offset between the beginning of the first of four PRN sequences generated in the third tracking channel 501c and the first of four PRN sequences generated in the second tracking channel 501b is one chip, and so on. This extends the length of the concatenated correlation window to three chips.

By extending the length of the correlation window to three chips (as opposed to the one chip tracking window of one tracking channel alone), it can be seen that correlation output values 701a₁ though 701a₄, 701b₁ though 701b₄, and 701c₁ though 701c₄ are generated. These four correlation output values can then be used as inputs to a signal processing algorithm as was discussed at FIG. 3.

In one embodiment, GNSS correlators can be used for terrestrial beacon tracking by combining several of the tracking channels of the GNSS receiver to produce a tracking window having a sufficient number of chips in length as is desirable for tracking a terrestrial positioning signal. In some cases, a GNSS receiver has multiple tracking channels to allow it to track satellites from several satellite systems. Accordingly, these tracking channels can be flexibly combined to provide several tracking windows of various lengths and sample rates.

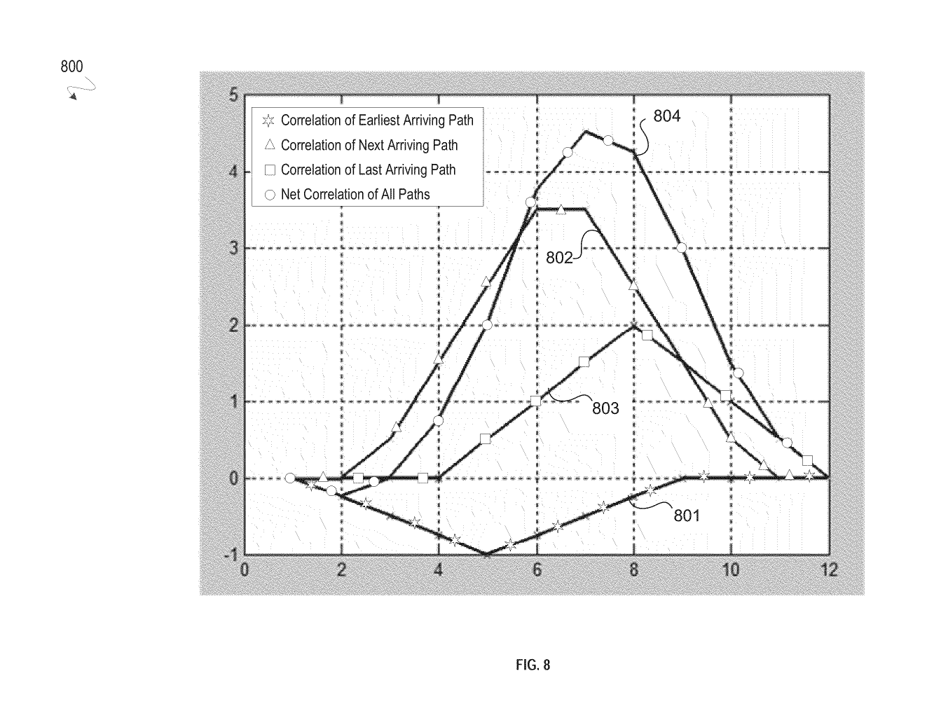

FIG. 8 depicts a graph of correlation output values at 4 samples per chip. The horizontal axis represents delay in units of 4 samples per chip. Curve 804 shows the net correlation function formed by the concatenation of 3 discrete channel paths represented by curves 801, 802 and 803, respectively. The curve 801 represents a channel path which arrives at the receiver at sample 5. The curve 802 represents a channel path which arrives at the receiver at sample 6.5. The curve 803 represents a channel path which arrives at the receiver at sample 8. Note that overall spread of the channel is 12 samples, or 3 chips. As shown, if a correlation window consisting of only four samples spanning a delay spread of one chip at the peak of the overall channel response at sample 7 was used to track the received positioning signals, then only the correlation response between sample 5 and 9 would be available to the signal processing algorithms that operate on the correlation function to determine the earliest time of arrival. As a result, data required to represent the full channel correlation function could not be gathered and only a truncated channel response would be available. With a truncated correlation function, full multipath resolution to determine earliest path time of arrival determination will not be possible to determine that the actual earliest time of arrival path is at sample 5.

### Interleaving Tracking Channels to Achieve a Higher Correlation Sampling Rate

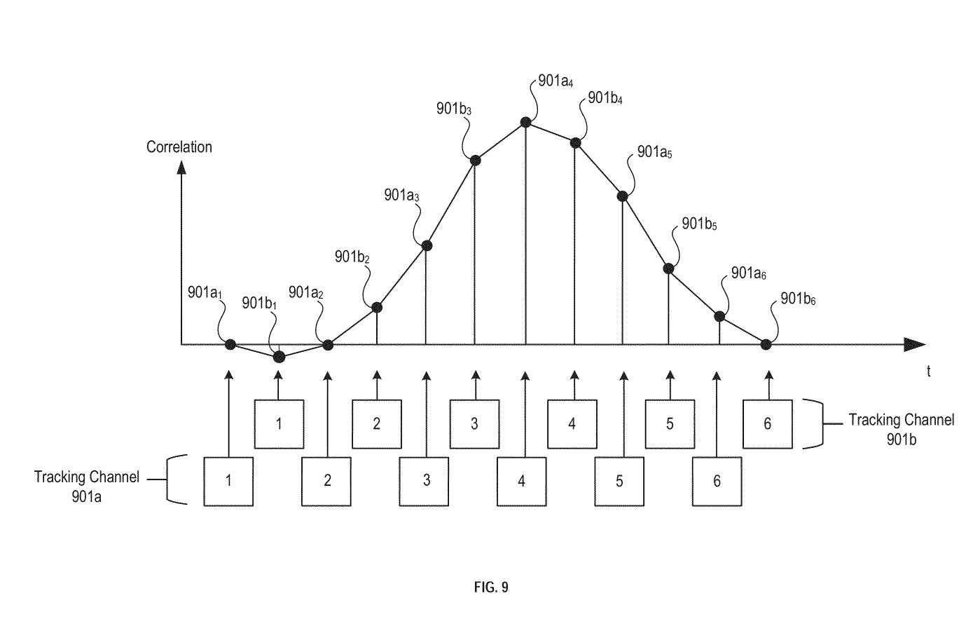

Use of high resolution signal processing algorithms such as those discussed at FIG. 3 (e.g., MUSIC) require a high correlation sampling rate (in addition to capturing the full duration of the channel correlation response) to determine the multipath components of received positioning signals. FIG. 9 depicts the correlation output values (901a₁ through 901a₆, and 901b₁ through 901b₆) resulting from interleaving two tracking channels 901a and 901b of six taps at a sample rate of two samples per chip to achieve an effective sample rate of four samples per chip spanning a delay spread of three chips.

As seen, the two tracking channels 901a and 901b produce six correlation output values per tracking channel. In this example the six correlation values from each of the tracking channels 901a and 901b span a width of three chips. Thus, by interleaving the chip samples of the two tracking channels 901a and 901b, a correlation window spanning three chips with a chip sampling resolution of four samples per chip is achieved.

To further elaborate, each of the tracking channels 901a and 901b is implemented in a manner similar to the tracking channel 301 of FIG. 3, with the addition of two more taps to each tracking channel for a total of six taps per tracking channel. Such a tracking channel will generate a PRN sequence of two samples per chip spanning two chips. That is, the programmable PRN generator of each of the tracking channels 901a and 901b has six taps to produce six instances of a locally generated PRN sequence offset in time.

Each PRN sequence is correlated against samples of the received positioning signal to produce a correlation output value. Therefore, two tracking channels interleaved with each other will use a total of twelve taps to generate twelve correlation output values (901a₁ through 901a₆, and 901bᵢ through 901b₆) over a correlation window spanning three chips.

The resulting chip sample rate is twice that of the chip sample rate provided by either of the tracking channels 901a and 901b taken alone.

In one embodiment, the two tracking channels 901a and 901b are programmed according to two of the tracking channels 501a and 501b of FIG. 5.

With further reference to FIG. 5, the correlation window seen in FIG. 9 is achieved by offsetting the start of the PRN sequence of the second tracking channel 501b from the start of the PRN sequence of the first tracking channel 501a by a fractional number of PRN chips (e.g., a quarter chip, a half a chip, etc.).

In one embodiment, the PRN sequence generated by the second tracking channel 501b begins a predetermined number of chips after the PRN sequence of the first tracking channel 501a.

In one such embodiment, the predetermined number is a half chip. Alternatively, the start of the PRN sequence of the second tracking channel 501b can be offset by an integer number of PRN chips plus a fraction of a chip.

In one embodiment, each of the tracking channels 501a and 501b performs six correlations spaced one half of a chip apart (e.g., a sampling rate of two samples per chip). The offset between the beginnings of the first of six PRN sequences generated in the second tracking channel 501b, with respect to the first of six PRN sequences generated in the first tracking channel 501a, is a quarter chip. This doubles the chip sampling rate over the correlation window.

The correlation outputs 901a₁ through 901a₆ interleaved with the correlation outputs 901b₁ through 901b₆ can then be used as inputs to a signal processing algorithm as was discussed at FIG. 3.

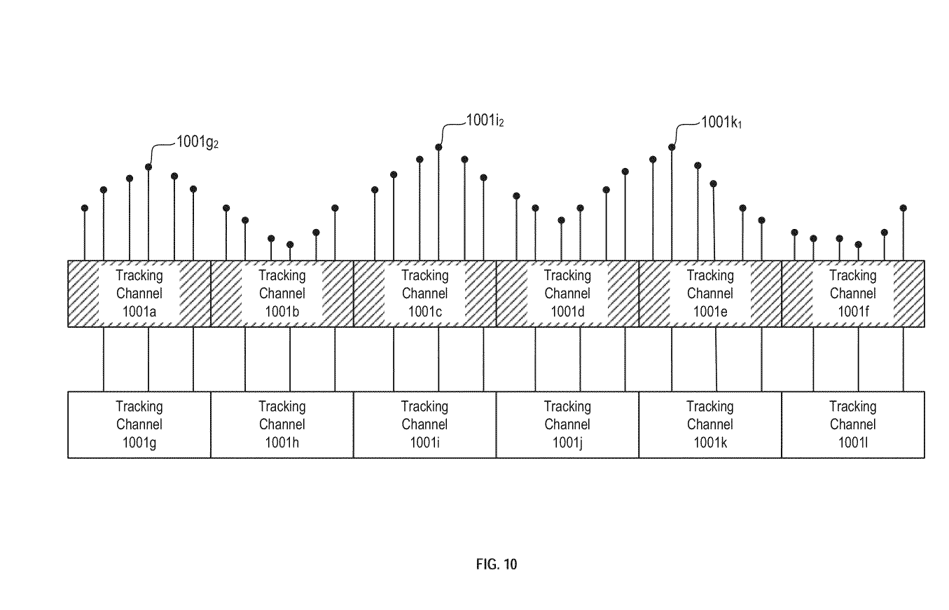

FIG. 10 is an illustration of a tracking window formed from concatenating twelve tracking channels 1001a through 1001l together. Each tracking channel provides three correlation outputs spanning one chip. The first six tracking channels 1001a through 1001f are controlled to form a contiguous tracking window 18 samples long spanning three chips. The second six tracking channels 1001g through 1001l are controlled to form a second contiguous tracking window that is also 18 samples long spanning three chips, but is offset by a fraction of a chip from the first six tracking channels 1001a through 100f. Therefore, the total tracking window has 36 correlation outputs over a span of three chips. The total sample rate for the combination of all twelve tracking channels 1001a through 1001l is two times the chipping rate of an individual tracking channel.

As can be seen in FIG. 10, there are three correlation peaks 1001g₂, 1001i₂ and 1001k₁ which represent three signals that appear within the tracking window. The first signal (represented by the peak 1001g₂) arrived two chips ahead of the second signal (represented by the peak 1001i₂). The second signal arrived two chips ahead of the third signal (represented by the peak 1001k₁). Without being able to correlate across a span of three chips, two of the three correlations values 1001g₂, 1001i₂, 1001k₁ would not have been observed.

### Processes for Combining Tracking Channels

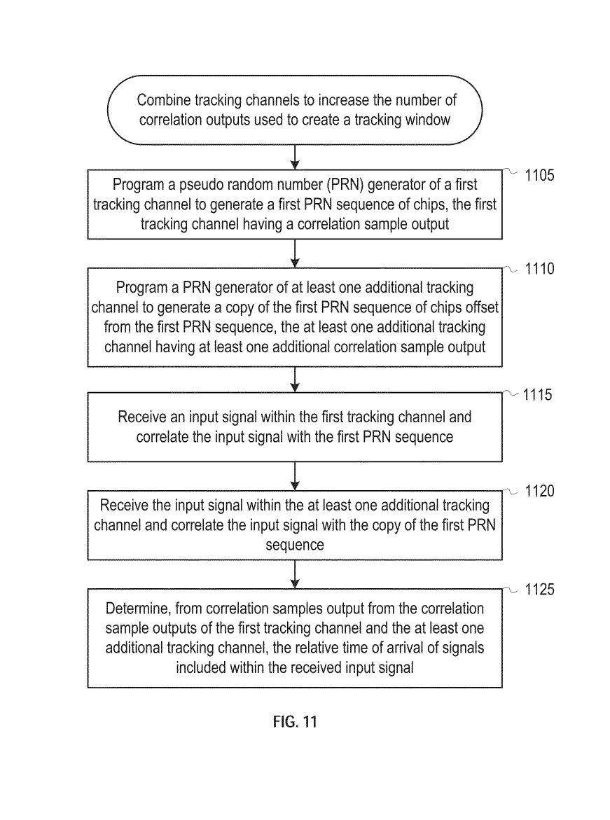

FIG. 11 details a process for combining tracking channels to increase the number of correlation outputs used to create a tracking window. The steps of the process include: programming a pseudo random number (PRN) generator of a first tracking channel to generate a first PRN sequence of chips, the first tracking channel having a correlation sample output (step 1105); programming a PRN generator of at least one additional tracking channel to generate a copy of the first PRN sequence of chips offset from the first PRN sequence, the at least one additional tracking channel having at least one additional correlation sample output (step 1110); receiving an input signal within the first tracking channel and correlating the input signal with the first PRN sequence (step 1115); receiving the input signal within the at least one additional tracking channel and correlating the input signal with the copy of the first PRN sequence (step 1120); and determining, from correlation samples output from the correlation sample outputs of the first tracking channel and the at least one additional tracking channel, the relative time of arrival of signals included within the received input signal (step 1125).

A set of tracking channels (including GNSS tracking correlator channels) can be controlled to operate in combination to either extend the length of a tracking window, increase the sample rate within a tracking window or both. Furthermore, groups of tracking channels can be used to generate non-contiguous tracking windows to track terrestrial multipath signals where the signals arrive within a receiver with a relatively long time between the first and last arriving signal. In one embodiment, information from an acquisition channel provides a starting point for aligning each of the tracking channels. Thereafter, peaks that are detected can be tracked by splitting the tracking correlators to track the peaks. Alternatively, one tracking channel, or group of tracking channels operating together, can be set up to track a “main” or “strongest peak” and one or more other channels can be offset to achieve an effective correlator that covers a larger delay spread (wider effective tracking window).

In one embodiment, GNSS tracking channels are used together with terrestrial beacon tracking channels. It should be noted that memory-based and shift-register-based correlator architectures can be used. Furthermore, methods and systems can be independent of the bandwidth of the signal being processed.

### Examples of Other Features in Some Embodiments

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s). Systems (e.g., apparatuses or components thereof) operable to implement the method(s) are also contemplated.

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

By way of example, not by way of limitation, method(s), system(s) or other means may include or be operable perform the following: instructing a pseudo random number (PRN) generator of a first tracking channel to generate a PRN sequence of chips (or generating, at a pseudo random number (PRN) generator of a first tracking channel, a PRN sequence of chips), the first tracking channel having a correlation sample output; instructing a PRN generator of a second tracking channel to generate a copy of the PRN sequence of chips (or generating, at a PRN generator of a second tracking channel, a copy of the PRN sequence of chips), the copy of the PRN sequence being offset from the PRN sequence, the second tracking channel having at least one correlation sample output; receiving an input signal within the first tracking channel and correlating the input signal with the PRN sequence; receiving the input signal within the second tracking channel and correlating the input signal with the copy of the PRN sequence; and determining, from correlation samples output from the correlation sample outputs of the first tracking channel and the second tracking channel, the relative times of arrival of different paths of the input signal.

In one embodiment, each of the tracking channels has one or more correlation outputs.

In one embodiment, the offset between each of the one or more correlation outputs from any one of the tracking channels is fixed.

In one embodiment, the copy of the PRN sequence is offset from the PRN sequence by an integer number of chips.

In one embodiment, the copy of the PRN sequence is offset from the PRN sequence by an integer number of chips plus a fraction of a chip.

Method(s), system(s) or other means may further or alternatively include or be operable to perform the following: instructing a third tracking channel to generate another copy of the PRN sequence, the other copy of the PRN sequence being offset from the PRN sequence or the copy of the PRN sequence by a fraction of a sample time of the sample clock, wherein a tracking window is created that is both longer than the tracking window of any individual one of the tracking channels and that has a higher sample rate than the tracking window of any individual one of the tracking channels.

In one embodiment, receiving the input signal includes sampling the input signal at a sample rate determined by a sample clock.

In one embodiment, each of the tracking channels has a sample clock, wherein the phase of one of the sample clocks is offset with respect to the phase of the other sample clock.

In one embodiment, each of the tracking correlators is a GNSS tracking correlator.

By way of example, not by way of limitation, system(s) or other means may include the following: a first tracking channel having (i) a first programmable pseudo random number (PRN) generator operable to output a PRN sequence of chips and (ii) a first correlator with an output; a second tracking channel having (i) a second programmable pseudo random number (PRN) generator operable to output a copy of the PRN sequence of chips and (ii) a second correlator with an output; and a controller coupled to at least one of the PRN generators, the controller operable to offset the PRN sequence and the copy of the PRN sequence from each other to generate a tracking window from the outputs of the first correlator and the second correlator.

In one embodiment, the controller is operable to extend the length of a tracking window by providing a program signal to the second PRN generator to begin the PRN sequence a predetermined number of chips after the beginning of the PRN sequence generated by the first PRN generator to thereby offset the PRN sequence by the predetermined number of chips from the copy of the PRN sequence.

In one embodiment, the predetermined number of chips is equal to the length of the tracking window of the first tracking channel.

In one embodiment, the offset generated by the controller offsets the PRN sequence from the copy of the PRN sequence by an integer number of chips.

In one embodiment, the offset generated by the controller offsets the PRN sequence from the copy of the PRN sequence by a fraction of a chip.

System(s) may further or alternatively include the following: a third tracking channel having (i) a third programmable pseudo random number (PRN) generator operable to output another copy of the PRN sequence of chips and (ii) a third correlator with an output, the controller coupled to the third PRN generator and operable to cause the third PRN generator to begin the other copy of the PRN sequence a fraction of a chip after the beginning of either the PRN sequence or the copy of the PRN sequence to generate a tracking window from the outputs of the first correlator, the second correlator and the third correlator, the tracking window being longer than the tracking window of any individual one of the tracking channels and that has a higher sample rate than the tracking window of any individual one of the tracking channels.

System(s) may further or alternatively include the following: a received signal register; and a sampling circuit having an input operable to receive a positioning signal and to provide samples of the received positioning signal to the received signal register, wherein the correlator in each tracking channel correlates the samples of the received positioning signal with the PRN sequence generated in the tracking channel in which the correlator resides.

System(s) may further or alternatively include the following: a sample clock coupled to the controller, the sample clock operable to receive a phase control signal from the controller and operable to output a sample clock signal to the sampling circuit to control when samples of the positioning signal are taken.

In one embodiment, the controller is operable to provide a phase control signal to plurality of tracking channels, and the controller is operable to control the phase of the sample clock in each of the plurality of tracking channel used to compose the tracking window to increase the number of samples per chip within the tracking window.

In one embodiment, the controller is operable to provide program signals to a plurality of tracking channels to create a tracking window that is longer than the tracking window of any individual one of the plurality of tracking channels, and the controller is operable to control the phase of the sample clock in each of the plurality of tracking channels to increase the number of samples per chip within the tracking window.

System(s) may further or alternatively include the following: a programmable selector having a positioning signal input, a channel selection input and at least two positioning signal outputs, the positioning signal input operable to receive the positioning signal, the channel selection input operable to receive a channel selection signal from the controller, and each positioning signal output operable to output the positioning signal to one of the tracking channels in response to the channel selection signal, the controller further having a channel selection output coupled to the channel selection input of the programmable selector, the controller operable to select which tracking channels receive the positioning signal based upon which tracking channels are to be used to form the tracking window.

A “receiver” may be in the form of a computing device (e.g., a mobile phone, a tablet, a PDA, a laptop, a digital camera, a tracking tag). A receiver may also take the form of any component of the computer, including a processor.

Processing by the receiver can also occur at a server.

The illustrative methods described herein may be implemented, performed, or otherwise controlled by suitable hardware known or later-developed by one of skill in the art, or by firmware or software executed by processor(s), or any combination of hardware, software and firmware. Software may be downloadable and non-downloadable at a particular system. Such software, once loaded on a machine, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement any or all of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

All of the information disclosed herein may be represented by data, and that data may be transmitted over any communication pathway using any protocol, stored on data source(s), and processed by a processor. Transmission of data may be carried out using a variety of wires, cables, radio signals and infrared light beams, and an even greater variety of connectors, plugs and protocols even if not shown or explicitly described. Systems may exchange information with each other using any communication technology. Data, instructions, commands, information, signals, bits, symbols, and chips and the like may be represented by voltages, currents, electromagnetic waves, magnetic fields or particles, or optical fields or particles.

Features in system figures that are illustrated as rectangles may refer to hardware, firmware or software. It is noted that lines linking two such features may be illustrative of data transfer between those features. Such transfer may occur directly between those features or through intermediate features. Where no line connects two features, transfer of data between those features is contemplated unless otherwise stated.

When two things (e.g., modules, circuit elements, etc.) are “coupled to” each other, those two things may be directly connected together, or may be separated by one or more intervening things. Thus, no direct connection is required between the two things. Where an output and an input are coupled to each other, data and/or signaling sent from the output is received by the input even if the data passes through one or more intermediate things.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for combining tracking channels to increase the number of correlation outputs used to create a tracking window, the method comprising:
generating a PRN sequence of chips at a pseudo random number (PRN) generator of a first tracking channel having a correlation sample output;
generating a copy of the PRN sequence of chips to use in a second tracking channel having at least one correlation sample output, wherein the copy of the PRN sequence is offset from the PRN sequence;
receiving an input signal within the first tracking channel;
correlating the input signal with the PRN sequence;
receiving the input signal within the second tracking channel;
correlating the input signal with the copy of the PRN sequence; and
determining the relative times of arrival of different paths of the input signal based on correlation samples output from the correlation sample outputs of the first tracking channel and the second tracking channel.

2. The method of claim 1, wherein each of the tracking channels has one or more correlation outputs.

3. The method of claim 2, wherein the offset between each of the one or more correlation outputs from any one of the tracking channels is fixed.

4. The method of claim 1, wherein the copy of the PRN sequence is offset from the PRN sequence by an integer number of chips.

5. The method of claim 1, wherein the copy of the PRN sequence is offset from the PRN sequence by an integer number of chips plus a fraction of a chip.

6. The method of claim 4, the method comprising:
generating an additional copy of the PRN sequence at a third tracking channel,
wherein the additional copy of the PRN sequence is offset from the PRN sequence or the copy of the PRN sequence by a fraction of a sample time of the sample clock, and
wherein a tracking window is created that is both longer than the tracking window of any individual one of the tracking channels and that has a higher sample rate than the tracking window of any individual one of the tracking channels.

7. The method of claim 1, wherein receiving the input signal includes sampling the input signal at a sample rate determined by a sample clock.

8. The method of claim 7, wherein each of the tracking channels has a sample clock, wherein the phase of one of the sample clocks is offset with respect to the phase of the other sample clock.

9. The method of claim 1, wherein each of the tracking correlators is a GNSS tracking correlator.

10. A receiver comprising:
a first tracking channel having (i) a first programmable pseudo random number (PRN) generator operable to output a PRN sequence of chips and (ii) a first correlator with an output;
a second tracking channel having (i) a second programmable pseudo random number (PRN) generator operable to output a copy of the PRN sequence of chips and (ii) a second correlator with an output; and
a controller coupled to at least one of the PRN generators, the controller operable to offset the PRN sequence and the copy of the PRN sequence from each other to generate a tracking window from the outputs of the first correlator and the second correlator.

11. The receiver of claim 10, wherein the controller is operable to extend the length of a tracking window by providing a program signal to the second PRN generator to begin the PRN sequence a predetermined number of chips after the beginning of the PRN sequence generated by the first PRN generator to thereby offset the PRN sequence by the predetermined number of chips from the copy of the PRN sequence.

12. The receiver of claim 11, wherein the predetermined number of chips is equal to the length of the tracking window of the first tracking channel.

13. The receiver of claim 11, wherein the offset generated by the controller offsets the PRN sequence from the copy of the PRN sequence by an integer number of chips.

14. The receiver of claim 11, wherein the offset generated by the controller offsets the PRN sequence from the copy of the PRN sequence by a fraction of a chip.

15. The receiver of claim 13, further comprising:
a third tracking channel having (i) a third programmable pseudo random number (PRN) generator operable to output an additional copy of the PRN sequence of chips and (ii) a third correlator with an output,
the controller coupled to the third PRN generator and operable to cause the third PRN generator to begin the additional copy of the PRN sequence a fraction of a chip after the beginning of either the PRN sequence or the copy of the PRN sequence to generate a tracking window from the outputs of the first correlator, the second correlator and the third correlator, the tracking window being longer than the tracking window of any individual one of the tracking channels and that has a higher sample rate than the tracking window of any individual one of the tracking channels.

16. The receiver of claim 10, the tracking channel further having:
a received signal register; and
a sampling circuit having an input operable to receive a positioning signal and to provide samples of the received positioning signal to the received signal register,
wherein the correlator in each tracking channel correlates the samples of the received positioning signal with the PRN sequence generated in the tracking channel in which the correlator resides.

17. The receiver of claim 16, further including:
a sample clock coupled to the controller, the sample clock operable to receive a phase control signal from the controller and operable to output a sample clock signal to the sampling circuit to control when samples of the positioning signal are taken.

18. The receiver of claim 17, the controller operable to provide a phase control signal to plurality of tracking channels, and the controller operable to control the phase of the sample clock in each of the plurality of tracking channel used to compose the tracking window to increase the number of samples per chip within the tracking window.

19. The receiver of claim 16, the controller operable to provide program signals to a plurality of tracking channels to create a tracking window that is longer than the tracking window of any individual one of the plurality of tracking channels, and the controller operable to control the phase of the sample clock in each of the plurality of tracking channels to increase the number of samples per chip within the tracking window.

20. The receiver of claim 10, the receiver further comprising:
a programmable selector having a positioning signal input, a channel selection input and at least two positioning signal outputs, the positioning signal input operable to receive the positioning signal, the channel selection input operable to receive a channel selection signal from the controller, and each positioning signal output operable to output the positioning signal to one of the tracking channels in response to the channel selection signal,
the controller further having a channel selection output coupled to the channel selection input of the programmable selector, the controller operable to select which tracking channels receive the positioning signal based upon which tracking channels are to be used to form the tracking window.
